(19) United States
(12) Patent Application Publication
(10) Pub. No.: US 2018/0376069 A1
(43) Pub. Date: Dec. 27, 2018

(54) ERRONEOUS OPERATION-PREVENTABLE ROBOT, ROBOT CONTROL METHOD, AND RECORDING MEDIUM

(71) Applicant: CASIO COMPUTER CO., LTD., Tokyo (JP)

(72) Inventor: Tetsuji Makino, Tokyo (JP)

(73) Assignee: CASIO COMPUTER CO., LTD., Tokyo (JP)

(21) Appl. No.: 15/988,667

(22) Filed: May 24, 2018

(30) Foreign Application Priority Data
Jun. 23, 2017 (JP) 2017-123607

(51) Int. Cl. H04N 5/232; G06K 9/00; G10L 25/63; B25J 11/00; B25J 9/16

(52) U.S. Cl. CPC H04N 5/23267; G06K 9/00664; G06K 9/00302; B25J 9/1697; H04N 5/23296; B25J 11/001; B25J 11/0015; G10L 25/63

(57) ABSTRACT

A robot includes an operation unit, an imager, an operation controller, a determiner, and an imager controller. The imager is disposed at a predetermined part of the robot and captures an image of a subject. The operation controller controls the operation unit to move the predetermined part. The determiner determines whether the operation controller is moving the predetermined part or not while the imager captures the image of the subject. The imager controller controls the imager or recording of the image of the subject that is captured by the imager, in a case in which the determiner determines that the operation controller is moving the predetermined part, so as to prevent motion of the predetermined part from affecting the image of the subject and causing the operation unit to perform an erroneous operation.

### CROSS-REFERENCE TO RELATED APPLICATION

This application is based upon and claims the benefit of priority from the prior Japanese Patent Application No. 2017-123607, filed Jun. 23, 2017, the entire contents of which are incorporated herein by reference.

### FIELD

This application relates generally to an erroneous operation-preventable robot, a robot control method, and a recording medium.

### BACKGROUND

Robots having a figure that imitates a human, an animal, or the like and capable of expressing emotions to a user are known. Unexamined Japanese Patent Application Kokai Publication No. 2016-101441 discloses a robot that includes a head-tilting mechanism that tilts a head and a head-rotating mechanism that rotates the head and implements emotional expression such as nodding or shaking of the head by a combined operation of head-tilting operation and head-rotating operation.

### SUMMARY

According to one aspect of a present disclosure, a robot includes an operation unit, an imager, an operation controller, a determiner, and an imager controller. The operation unit causes the robot to operate. The imager is disposed at a predetermined part of the robot and captures an image of a subject. The operation controller controls the operation unit to move the predetermined part. The determiner determines whether the operation controller is moving the predetermined part while the imager captures the image of the subject. The imager controller controls the imager or recording of the image of the subject that is captured by the imager, in a case in which the determiner determines that the operation controller is moving the predetermined part, so as to prevent motion of the predetermined part from affecting the image of the subject and causing the operation unit to perform an erroneous operation.

According to another aspect of the present disclosure, a method for controlling a robot that includes an operation unit that causes the robot to operate and an imager that is disposed at a predetermined part of the robot and captures an image of a subject, includes controlling the operation unit to move the predetermined part, determining whether the predetermined part is being moved in the controlling of the operation unit or not while the imager captures the image of the subject, and controlling the imager or recording of the image of the subject that is captured by the imager, in a case in which a determination is made that the predetermined part is being moved, so as to prevent motion of the predetermined part from affecting the image of the subject and causing the operation unit to perform an erroneous operation.

According to yet another aspect of the present disclosure, a non-transitory computer-readable recording medium stores a program. The program causes a computer that controls a robot including an operation unit that causes the robot to operate and an imager that is disposed at a predetermined part of the robot and captures an image of a subject to function as an operation controller, a determiner, an imager controller. The operation controller controls the operation unit to move the predetermined part. The determiner determines whether the operation controller is moving the predetermined part or not while the imager captures the image of the subject. The imager controller controls the imager or recording of the image of the subject that is captured by the imager, in a case in which the determiner determines that the operation controller is moving the predetermined part, so as to prevent motion of the operation unit part from affecting the image of the subject and causing the operation unit to perform an erroneous operation.

Additional objectives and advantages of the present disclosure will be set forth in the description which follows, and in part will be obvious from the description, or may be learned by practice of the present disclosure. The objectives and advantages of the present disclosure may be realized and obtained by means of the instrumentalities and combinations particularly pointed out hereinafter.

### BRIEF DESCRIPTION OF THE DRAWINGS

The accompanying drawings, which are incorporated in and constitute a part of a specification, illustrate embodiments of the present disclosure, and together with the general description given above and the detailed description of the embodiments given below, serve to explain principles of the present disclosure.

A more complete understanding of this application can be obtained when the following detailed description is considered in conjunction with the following drawings, in which:

FIG. 1 is an illustration that shows a robot according to Embodiment 1 of the present disclosure;

FIG. 2 is a block diagram that shows a configuration of the robot according to the Embodiment 1 of the present disclosure;

FIG. 3 is a flowchart that shows an emotional expression procedure according to the Embodiment 1 of the present disclosure;

FIG. 4 is an illustration that shows a robot according to Embodiment 2 of the present disclosure;

FIG. 5 is a block diagram that shows a configuration of the robot according to the Embodiment 2 of the present disclosure;

FIG. 6 is a flowchart that shows an emotional expression procedure according to the Embodiment 2 of the present disclosure;

FIG. 7 is a flowchart that shows an emotional operation procedure according to the Embodiment 2 of the present disclosure;

FIG. 8 is an illustration that shows an image that is captured by an imager according to a modified embodiment of the Embodiment 2 of the present disclosure;

FIG. 9 is an illustration that shows an image that is captured by the imager according to the modified embodiment of the Embodiment 2 of the present disclosure;

FIG. 10 is an illustration that shows an image that is captured by the imager according to the modified embodiment of the Embodiment 2 of the present disclosure;

FIG. 11 is an illustration that shows a robot according to Embodiment 3 of the present disclosure;

FIG. 12 is a block diagram that shows a configuration of the robot according to the Embodiment 3 of the present disclosure;

FIG. 13 is a flowchart that shows an emotional expression procedure according to the Embodiment 3 of the present disclosure; and

FIG. 14 is a flowchart that shows an emotional operation procedure according to the Embodiment 3 of the present disclosure.

### DETAILED DESCRIPTION

A robot according to embodiments for implementing the present disclosure will be described below with reference to the drawings.

### Embodiment 1

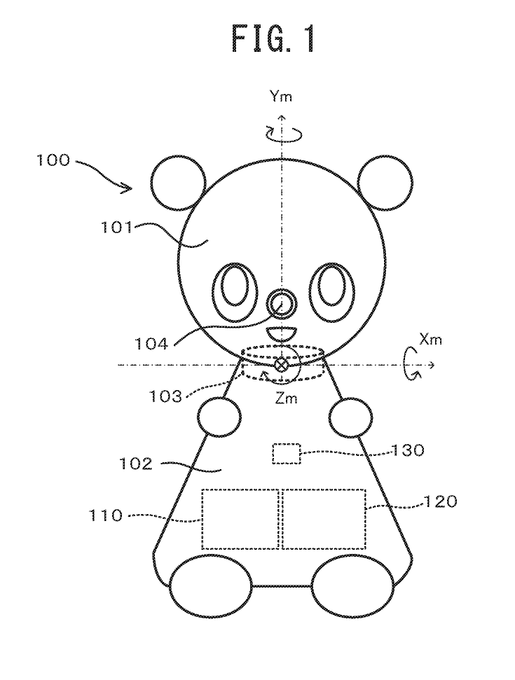

A robot according embodiments of the present disclosure is a robot device that autonomously operates in accordance with a motion, an expression, or the like of a predetermined target such as a user so as to perform an interactive operation through interaction with the user. This robot has an imager on a head. The imager, which captures images, captures the user's motion, the user's expression, or the like. A robot 100 has, as shown in FIG. 1, a figure that is deformed from a human and includes a head 101, which is a predetermined part, on which members that imitate eyes and ears are disposed, a body 102 on which members that imitate hands and feet are disposed, a neck joint 103 that connects the head 101 to the body 102, an imager 104 that is disposed on the head 101, a controller 110 and a power supply 120 that are disposed within the body 102, and an operation button 130 that is provided on a back of the body 102.

The neck joint 103 is a member that connects the head 101 and the body 102 and has multiple motors that rotate the head 101. The multiple motors are driven by the controller 110 that is described later. The head 101 is rotatable with respect to the body 102 by the neck joint 103 about a pitch axis Xm, about a roll axis Zm, and about a yaw axis Ym. The neck joint 103 is one example of an operation unit.

The imager 104 is provided in a lower part of a front of the head 101, which corresponds to a position of a nose in a human face. The imager 104 captures an image of a predetermined target in every predetermined time (for example, in every 1/60 second) and outputs the captured image to the controller 110 that is described later based on control of the controller 110.

The power supply 120 includes a rechargeable battery that is built in the body 102 and supplies electric power to parts of the robot 100.

The operation button 130 is provided on the back of the body 102, is a button for operating the robot 100, and includes a power button.

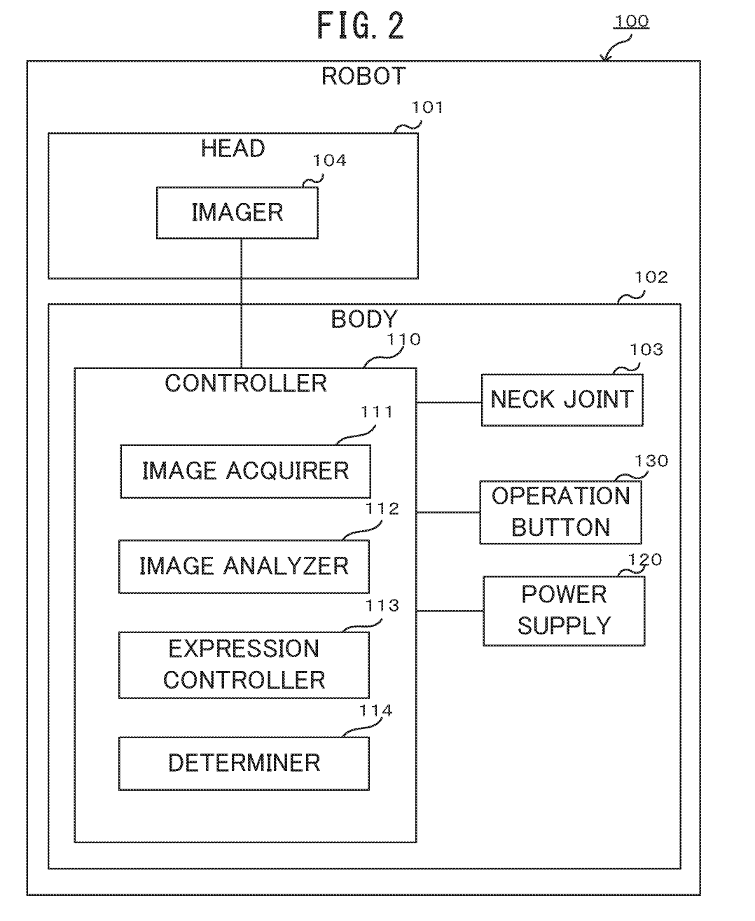

The controller 110 includes a central processing unit (CPU), a read only memory (ROM), and a random access memory (RAM). As the CPU reads a program that is stored in the ROM and executes the program on the RAM, the controller 110 functions as, as shown in FIG. 2, an image acquirer 111, an image analyzer 112, an expression controller (operation controller) 113, and a determiner 114.

The image acquirer 111 controls imaging operation of the imager 104, acquires the image that is captured by the imager 104, and stores the acquired image in the RAM. The image acquirer 111 acquires the image that is captured by the imager 104 when an emotional operation flag, which is described layer, is OFF and suspends acquisition of the image that is captured by the imager 104 when the emotional operation flag is ON. Alternatively, the image acquirer 111 suspends recording of the image that is captured by the imager 104. In the following explanation, the image that is acquired by the image acquirer 111 is also referred to as the acquired image. The image acquirer 111 functions as an imager controller.

The image analyzer 112 analyzes the acquired image that is stored in the RAM and determines a facial expression of the user. The facial expression of the user includes an expression of “joy” and an expression of “anger”. First, the image analyzer 112 detects a face of the user using a known method. For example, the image analyzer 112 detects a part in the acquired image that matches a human face template that is prestored in the ROM as the face of the user. When the face of the user is not detected in a center of the acquired image, the image analyzer 112 turns the head 101 up, down, right or left and stops the head 101 in the direction in which the face of the user is detected in the center of the acquired image. Next, using a known method, the image analyzer 112 determines the expression based on a shape of a mouth that appears in the part that is detected as the face in the acquired image. For example, if determining that the mouth has a shape with corners upturned, the image analyzer 112 determines that the expression is an expression of “joy”. If determining that the mouth has a shape with the corners downturned, the image analyzer 112 determines that the expression is an expression of “anger”.

The expression controller 113 controls the neck joint 103 to make the head 101 perform an emotional operation based on the facial expression of the user that is determined by the image analyzer 112. For example, in a case in which the image analyzer 112 determines that the expression of the user is the expression of “joy”, the expression controller 113 controls the neck joint 103 to make the head 101 oscillate about the pitch axis Xm as the emotional operation to shake the head 101 vertically (nodding operation). In a case in which the image analyzer 112 determines that the expression of the user is the expression of “anger”, the expression controller 113 controls the neck joint 103 to make the head 101 oscillate about the yaw axis Ym as the emotional operation to shake the head 101 horizontally (head-shaking operation). As the emotional operation starts, the expression controller 113 switches the emotional operation flag to ON and stores a result in the RAM. As a result, a control mode of the expression controller 113 is changed. The expression controller 113 stops the emotional operation when a specific time (for example, five seconds) elapses since the emotional operation starts.

The determiner 114 determines whether the robot 100 is performing the emotional operation by the expression controller 113 or not. If determining that the robot 100 has finished the emotional operation, the determiner 114 switches the emotional operation flag to OFF and stores the result in the RAM. If determining that the robot 100 has not finished the emotional operation, the determiner 114 keeps the emotional operation flag ON. Here, when powered on, the determiner 114 switches the emotional operation flag to OFF and stores the result in the RAM.

An emotional expression procedure that is executed by the robot 100 that has the above configuration will be described next. The emotional expression procedure is a procedure to determine the facial expression of the user and make the head 101 operate according to the facial expression of the user.

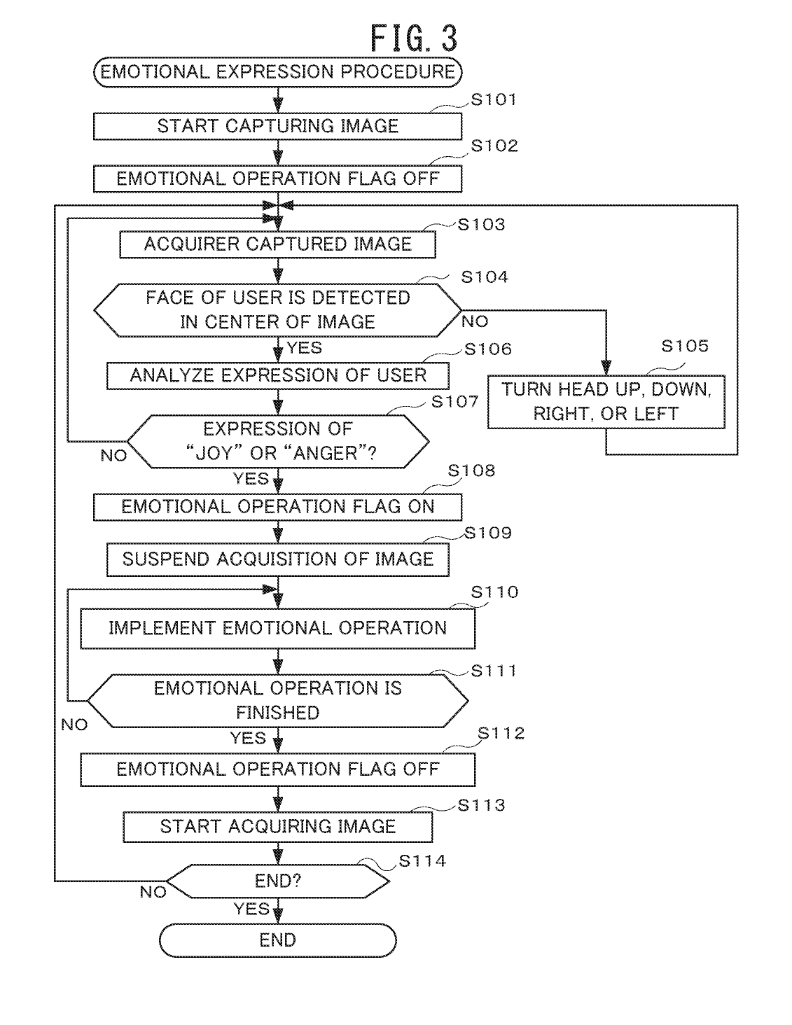

As the user operates the operation button 130 to power on, the robot 100 responds to a power-on order and starts the emotional expression procedure shown in FIG. 3. The emotional expression procedure that is executed by the robot 100 will be described below using a flowchart.

First, the image acquirer 111 makes the imager 104 start capturing the image (Step S101). Next, the determiner 114 switches the emotional operation flag to OFF and stores the result in the RAM (Step S102). Next, the image acquirer 111 acquires the image that is captured by the imager 104 (Step S103). The image acquirer 111 stores the acquired image in the RAM.

Next, using the known method, the image analyzer 112 analyzes the acquired image, detects the face of the user, and determines whether the face of the user is detected in the center of the acquired image or not (Step S104). For example, the image analyzer 112 detects the part in the acquired image that matches the human face template that is prestored in the ROM as the face of the user and determines whether the detected face is positioned in the center of the acquired image. If the image analyzer 112 determines that the face of the user is not detected in the center of the acquired image (Step S104; NO), the image analyzer 112 turns the head 101 of the robot 100 in any of upward, downward, rightward, and leftward directions (Step S105). For example, if the face of the user is detected in the right part of the acquired image, the image analyzer 112 rotates the head 101 about the yaw axis Ym to turn left. Next, returning to the Step S103, the image analyzer 112 acquires a new captured image (Step S103). Next, the image analyzer 112 determines whether the face of the user is detected in the center of the new acquired image or not (Step S104).

Next, if determining that the face of the user is detected in the center of the acquired image (Step S104; YES), the image analyzer 112 analyzes the expression of the user (Step S106). Next, the image analyzer 112 determines whether the expression of the user is the expression of “joy” or “anger” (Step S107). For example, if determining that the mouth has the shape with the corners upturned, the image analyzer 112 determines that the expression is the expression of “joy”. If determining that the mouth has the shape with the corners downturned, the image analyzer 112 determines that the expression is the expression of “anger”. Next, if determining that the expression of the user is not the expression of “joy” or “anger” (Step S107; NO), the image analyzer 112 returns to the Step S103 and repeats the Steps S103 through S107.

Next, if determining that the expression of the user is the expression of “joy” or “anger” (Step S107; YES), the expression controller 113 switches the emotional operation flag to ON and stores the result in the RAM (Step S108). Next, the image acquirer 111 suspends acquisition of the image (Step S109). In other words, capturing of the image by the imager 104 is suspended or recording of the image that is captured by the imager 104 is suspended. The expression controller 113 controls the neck joint 103 to make the head 101 perform the emotional operation based on the facial expression of the user that is determined by the image analyzer 112 (Step S110). For example, in the case of determining that the expression of the user is the expression of “joy”, the expression controller 113 controls the neck joint 103 to make the head 101 oscillate about the pitch axis Xm as the emotional operation to shake the head 101 vertically. In the case in which the image analyzer 112 determines that the expression of the user is the expression of “anger”, the expression controller 113 controls the neck joint 103 to make the head 101 oscillate about the yaw axis Ym as the emotional operation to shake the head 101 horizontally.

Next, the determiner 114 determines whether the robot 100 has finished the emotional operation by the expression controller 113 or not (Step S111). If the determiner 114 determines that the emotional operation is not finished (Step S111; NO), the processing returns to the Step S110 and the Steps S110 through S111 are repeated until the emotional operation is finished. Here, the expression controller 113 stops the emotional operation when the specific time (for example, five seconds) elapses since the emotional operation starts.

If determining that the emotional operation is finished (Step S111; YES), the determiner 114 switches the emotional operation flag to OFF and stores the result in the RAM (Step S112). Next, the image acquirer 111 starts acquiring the image (Step S113). Next, the determiner 114 determines whether an end order is entered in the operation button 130 by the user (Step S114). If no end order is entered in the operation button 130 (Step S114; NO), the processing returns to the Step S103 and the Steps S103 through S114 are repeated. If the end order is entered in the operation button 130 (Step S114; YES), the emotional expression procedure ends.

As described above, the robot 100 starts acquiring the image that is captured by the imager 104 in the case in which the emotional expression is not implemented and the image acquirer 111 suspends acquisition of the image that is captured by the imager 104 in the case in which the emotional expression is implemented. As a result, the image analyzer 112 analyzes the expression of the user while the head 101 is not moving. On the other hand, the image analyzer 112 suspends analysis of the expression of the user while the head 101 is moving for expressing an emotion. Therefore, the robot 100 can implement the emotional expression based on an unblurred image that is captured while the head 101 is not moving. The image that is captured while the head 101 is moving may be blurred and the robot 100 does not acquire the image that is captured while the head 101 is moving. As a result, it is possible to prevent erroneous operations of the robot 100. Moreover, when the face of the user is not detected in the center of the acquired image, the robot 100 turns the head 101 up, down, right, or left and stops the head 101 in the direction in which the face of the user is detected in the center of the acquired image. As a result, it is possible to make a gaze of the head 101 of the robot 100 look like being on the user.

### Modified Embodiment of Embodiment 1

The robot 100 of the Embodiment 1 is described regarding the case in which the image acquirer 111 acquires the image that is captured by the imager 104 in the case in which no emotional operation is implemented and the image acquirer 111 suspends acquisition of the image that is captured by the imager 104 in the case in which the emotional operation is implemented. The robot 100 of the Embodiment 1 has only to be capable of analyzing the expression of the user in the case in which no emotional operation is implemented and suspending analysis of the expression of the user in the case in which the emotional operation is implemented. For example, the image acquirer 111 may control the imager 104 to capture the image in the case in which no emotional operation is implemented and control the imager 104 to suspend capture of the image in the case in which the emotional operation is implemented. Moreover, the image analyzer 112 may be controlled to analyze the expression of the user in the case in which no emotional operation is implemented and suspend analysis of the expression of the user in the case in which the emotional operation is implemented.

Moreover, in the robot 100, it may be possible that the expression controller 113 records in the RAM an angle of the neck joint 103 immediately before implementing the emotional operation and when the emotional operation is finished, returns the angle of the neck joint 103 to the angle of the neck joint 103 immediately before implementing the emotional operation. In this way, it is possible to turn the gaze of the head 101 to the user after the emotional operation is finished.

Moreover, the image analyzer 112 may prestore data of the face of a specific person in the ROM. It may be possible that the expression controller 113 executes the emotional operation of the head 101 when the image analyzer 112 determines that the prestored face of the specific person appears in the image that is acquired by the image acquirer 111.

### Embodiment 2

The robot 100 of the above Embodiment 1 is described regarding the case in which analysis of the expression of the user is suspended in the case in which the emotional expression is implemented. A robot 200 of Embodiment 2 is described regarding a case in which an image-capturing range is shifted up, down, right, or left so as to cancel a motion of the head 101 out in a case in which an emotional expression is implemented.

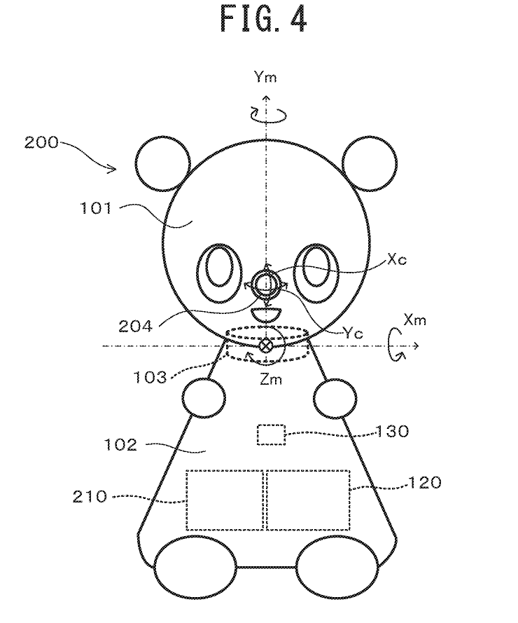

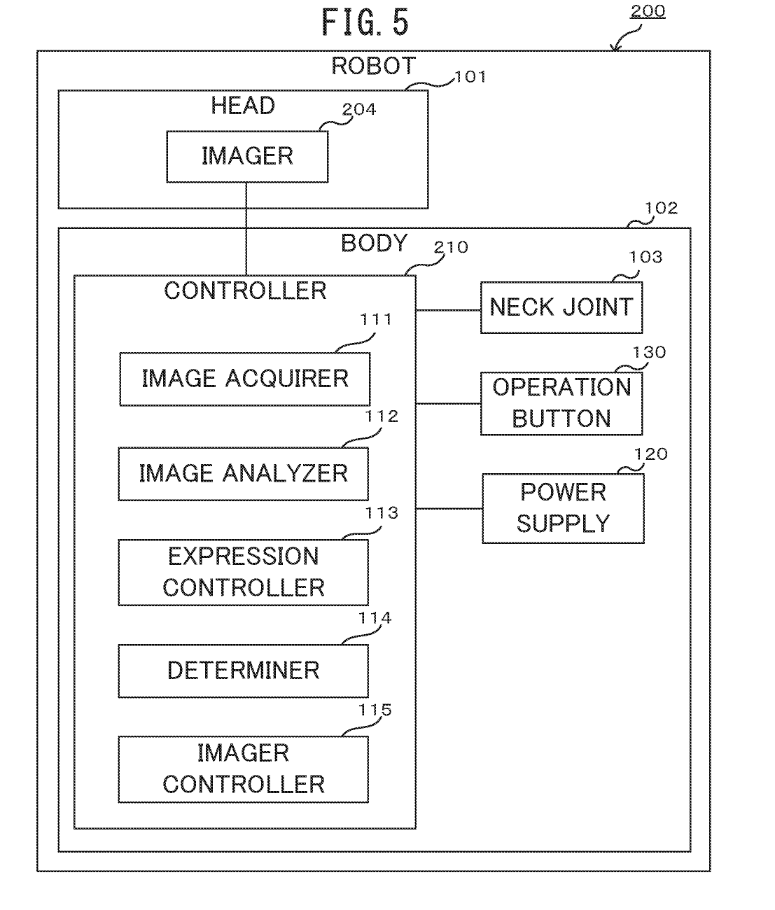

In the robot 200 of the Embodiment 2, as shown in FIG. 4, an imager 204 is disposed so that an optical axis of a lens moves in a vertical direction Xc and in a horizontal direction Yc. Moreover, a controller 210 of the Embodiment 2 functions as, as shown in FIG. 5, an imager controller 115 in addition to the function of the controller 110 of the robot 100 of the Embodiment 1. The other configuration of the robot 200 of the Embodiment 2 is the same as in the Embodiment 1.

The imager 204 shown in FIG. 4 is disposed in the lower part of the front of the head 101, which corresponds to the position of the nose in the human face. The imager 204 captures an image of a predetermined target in every predetermined time and outputs the captured image to the controller 210 that is described later based on a control of the controller 210. Moreover, in the imager 204, the optical axis of the lens swings in the vertical direction Xc to shift the imaging range up or down and the optical axis of the lens swings in the horizontal direction Yc to shift the imaging range right or left based on the control of the controller 210.

The imager controller 115 shown in FIG. 5 controls an orientation of the imager 204 so as to cancel the motion of the head 101 out when the emotional operation flag is ON. When the head 101 oscillates about the pitch axis Xm, the imager 204 swings in the vertical direction Xc so as to cancel the motion of the head 101 out based on the control of the controller 210. When the head 101 oscillates about the yaw axis Ym, the imager 204 swings in the horizontal direction Yc so as to cancel the motion of the head 101 out based on the control of the controller 210.

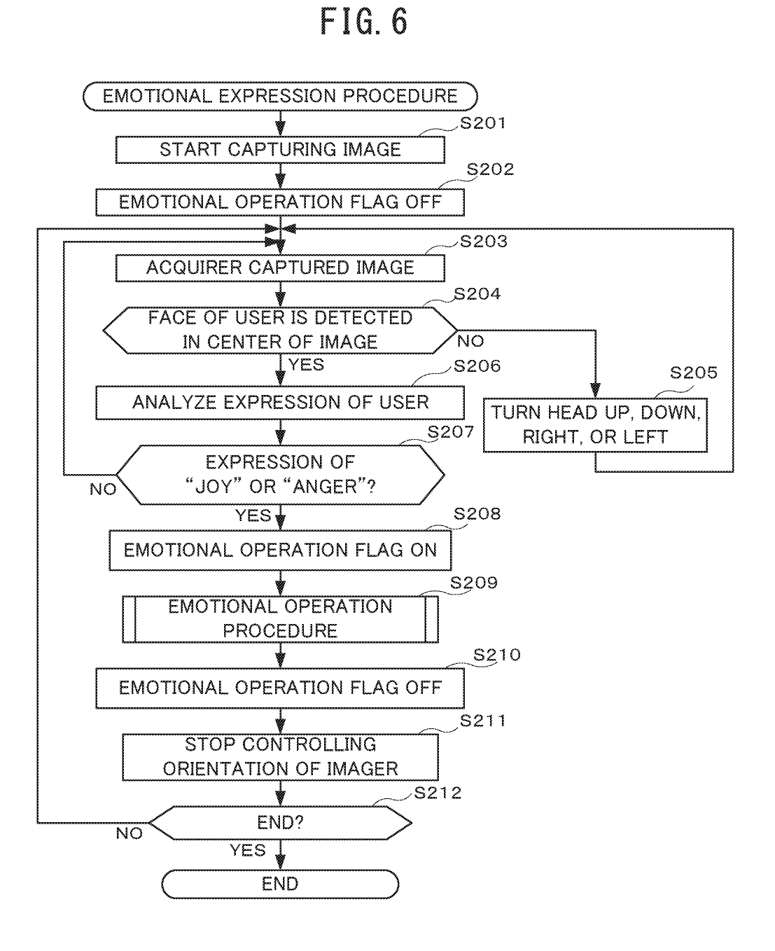

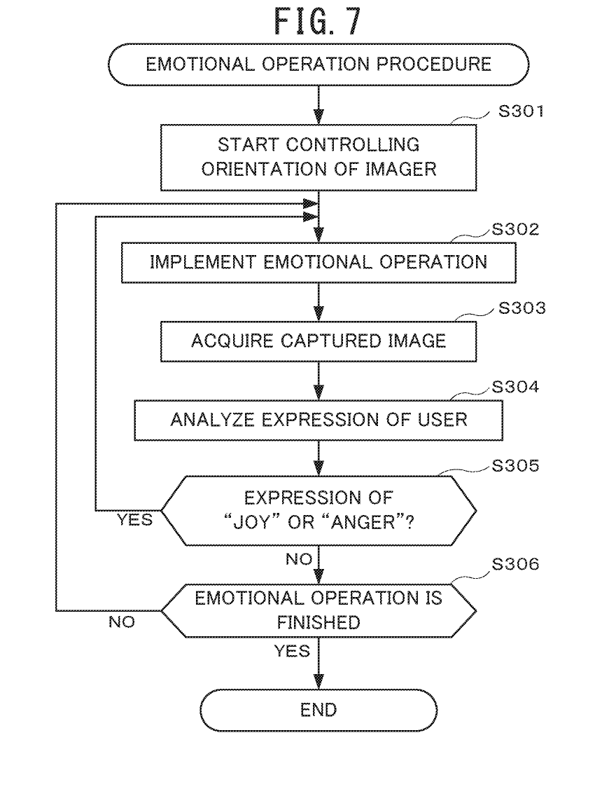

An emotional expression procedure that is executed by the robot 200 that has the above configuration will be described next. Steps S201 through S208 of the emotional expression procedure of Embodiment 2 are the same as the Steps S101 through S108 of the emotional expression procedure of the Embodiment 1. The emotional expression procedure of Step S209 and subsequent steps will be described with reference to FIG. 6 and FIG. 7.

As the expression controller 113 switches the emotional operation flag to ON and stores the result in the RAM in Step S208, the expression controller 113 executes the emotional operation procedure (Step S209). As the emotional operation procedure starts, as shown in FIG. 7, the imager controller 115 starts controlling the orientation of the optical axis of the lens of the imager 204 so as to cancel the motion of the head 101 out (Step S301). Specifically, when the head 101 oscillates about the pitch axis Xm, the imager controller 115 starts controlling the imager 204 to swing in the vertical direction Xc so as to cancel the motion of the head 101 out based on the control of the controller 210. When the head 101 oscillates about the yaw axis Ym, the imager controller 115 starts controlling the imager 204 to swing in the horizontal direction Yc so as to cancel the motion of the head 101 out based on the control of the controller 210.

Next, the expression controller 113 controls the neck joint 103 to make the head 101 operate based on the facial expression of the user that is determined by the image analyzer 112 (Step S302). For example, in the case of determining that the expression of the user is the expression of “joy”, the expression controller 113 controls the neck joint 103 to make the head 101 oscillate about the pitch axis Xm as the emotional operation to shake the head 101 vertically. In the case in which the image analyzer 112 determines that the expression of the user is the expression of “anger”, the expression controller 113 controls the neck joint 103 to make the head 101 oscillate about the yaw axis Ym as the emotional operation to shake the head 101 horizontally. At this point, the imager controller 115 controls the orientation of the optical axis of the lens of the imager 204 so as to cancel the motion of the head 101 out. Therefore, the imager 204 can capture an unblurred image.

Next, the image acquirer 111 acquires the image in which the user is captured (Step S303). Next, the image analyzer 112 analyzes the expression of the user (Step S304). Next, the image analyzer 112 determines whether the expression of the user is the expression of “joy” or “anger” (Step S305). For example, if determining that the mouth has the shape with the corners upturned, the image analyzer 112 determines that the expression of the user is the expression of “joy”.

If determining that the mouth has the shape with the corners downturned, the image analyzer 112 determines that the expression of the user is the expression of “anger”. Next, if the image analyzer 112 determines that the expression of the user is the expression of “joy” or “anger” (Step S305; YES), the processing returns to the Step S302 and the neck joint 103 is controlled to make the head 101 perform the emotional operation based on a newly determined facial expression of the user (Step S302).

If determining that the expression of the user is not the expression of “joy” or “anger” (Step S305; NO), the determiner 114 determines whether the robot 100 has finished the emotional operation by the expression controller 113 or not (Step S306). If the determiner 114 determine that the emotional operation is not finished (Step S306; NO), the processing returns to the Step S302 and the Steps S302 through S306 are repeated until the emotional operation is finished. Here, the expression controller 113 stops the emotional operation when the specific time elapses since the emotional operation starts.

If determining that the emotional operation is finished (Step S306; YES), the determiner 114 returns to FIG. 6 and switches the emotional operation flag to OFF and stores the result in the RAM (Step S210). Next, the imager controller 115 stops controlling the orientation of the optical axis of the lens of the imager 204 (Step S211). Next, the determiner 114 determines whether the end order is entered in the operation button 130 by the user or not (Step S212). If no end order is entered in the operation button 130 (Step S212; NO), the processing returns to the Step S203 and the Steps S203 through S212 are repeated. If the end order is entered in the operation button 130 (Step S212; YES), the emotional expression procedure ends.

As described above, according to the robot 200, the imager controller 115 controls the orientation of the imager 204 so as to cancel the motion of the head 101 out in the case in which the emotional expression is implemented. As a result, the image that is captured by the imager 204 while the emotional operation is implemented is less blurred. Therefore, it is possible to analyze the expression of the user precisely even while the emotional expression is implemented and prevent erroneous operations of the robot 200. Moreover, the robot 200 can analyze the expression of the user while the emotional expression is implemented. Hence, for example, in the case in which the robot 200 analyzes the expression of the user and determines that the expression of the user is of “anger” while performing the emotional expression of “joy”, the robot 200 can change to the emotional expression of “anger”.

### Modified Embodiment of Embodiment 2

The robot 200 of Embodiment 2 is described regarding the case in which the imager controller 115 controls the orientation of the imager 204 so as to cancel the motion of the head 101 out while the emotional operation is implemented. The robot 200 of Embodiment 2 is not confined to this case as long as the captured image can be made less blurred. For example, the image acquirer 111 may acquire the image by trimming an image that is captured by the imager 204 and change a trimming range of the image so as to cancel the motion of the head 101 out.

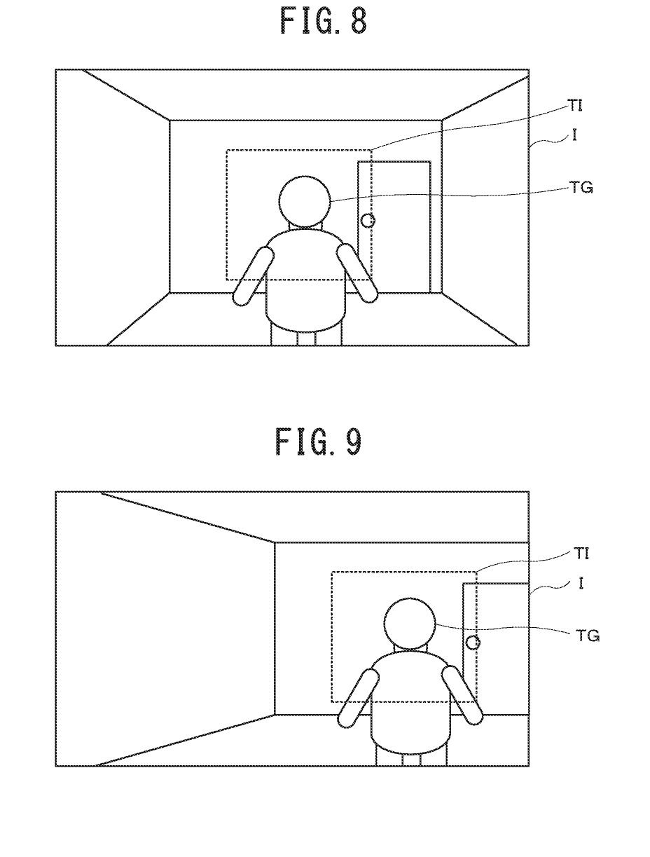

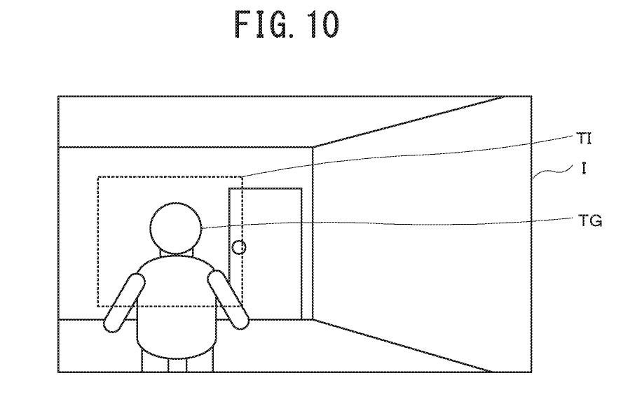

Specifically, as shown in FIG. 8, the image acquirer 111 acquires a trimmed image TI that is obtained by cutting out a portion of an image I so as to include a predetermined target TG such as the user. The image analyzer 112 analyzes the trimmed image TI and determines the expression of the predetermined target TG such as the user. At this point, the predetermined target TG appears in a center of the image I. As the head 101 turns left for expressing an emotion, as shown in FIG. 9, the imaging region shifts to the left. Therefore, the predetermined target TG that appears in the image I shifts to the right in the image I. Then, the image acquirer 111 shifts the trimming range to the right by the left turn of the head 101. The image acquirer 111 acquires the trimmed image TI shown in FIG. 9. As the head 101 turns right, as shown in FIG. 10, the imaging region shifts to the right. Therefore, the predetermined target TG that appears in the image I shifts to the left in the image I. Then, the image acquirer 111 shifts the trimming range to the left by the right turn of the head 101. The image acquirer 111 acquires the trimmed image TI shown in FIG. 10. In a case in which the head 101 turns up or down, the trimming range is changed to be upper or lower. In this way, it is possible to obtain the less blurred image without moving the imager 204 and prevent erroneous operations of the robot 100. Here, it is recommended that the imager 204 includes a wide-angle lens or a fish-eye lens. In this way, it is possible to capture the image of the predetermined target TG even if an oscillation angle of the head 101 is large.

### Embodiment 3

The robot 100 of Embodiment 1 and the robot 200 of Embodiment 2 are described above regarding the case in which the imager 104 or 204 captures the image of the predetermined target to express the emotion. A robot 300 of Embodiment 3 is described regarding a case in which an emotion is expressed based on sound that is collected by microphones.

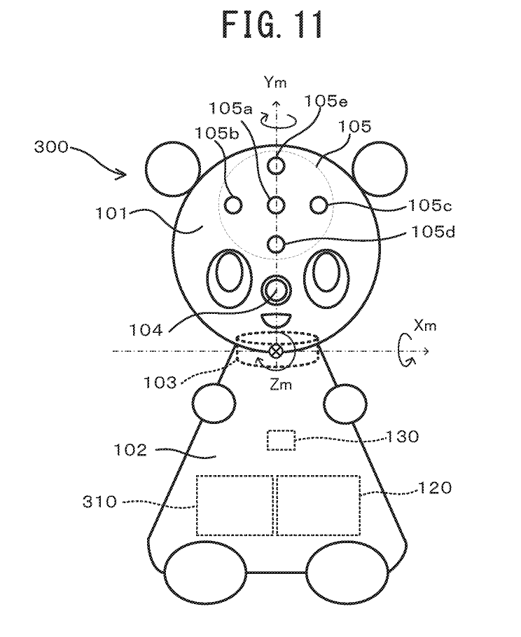

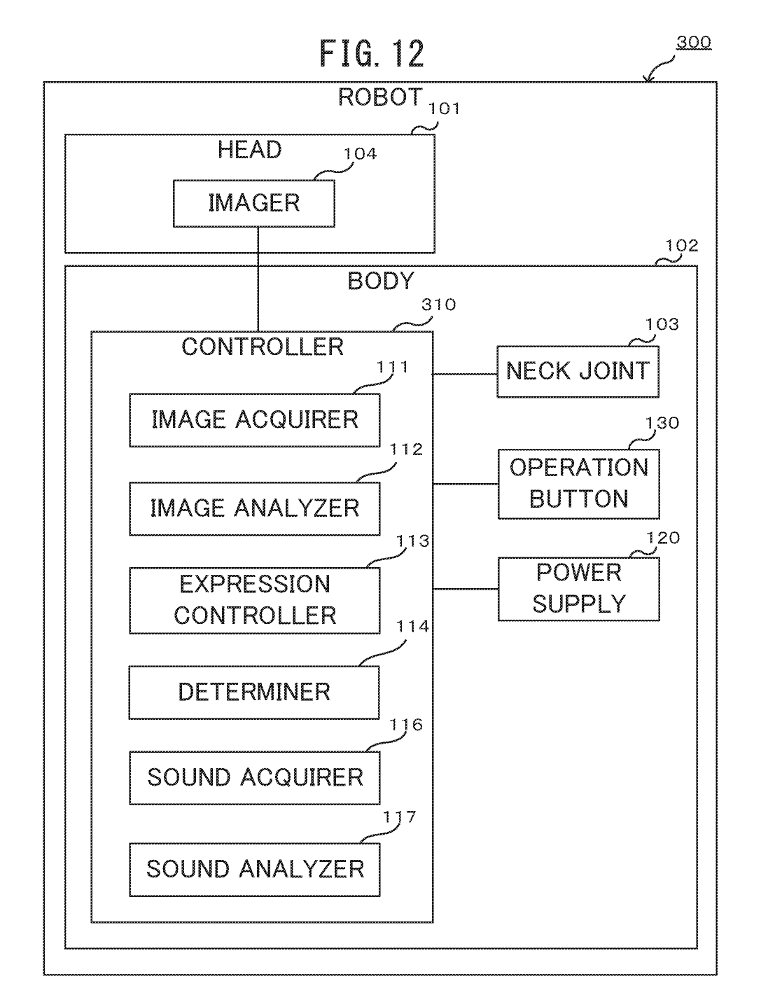

The robot 300 of the Embodiment 3 includes, as shown in FIG. 11, a set of microphones 105 that collects the sound. Moreover, a controller 310 of the Embodiment 3 functions as, as shown in FIG. 12, a sound acquirer 116 and a sound analyzer 117 in addition to the function of the controller 110 of the robot 100 of the Embodiment 1. The other configuration of the robot 300 of the Embodiment 3 is the same as in the Embodiment 1.

The set of microphones 105 shown in FIG. 11 is disposed on the head 101 at a position that corresponds to a forehead in a human face, includes five microphones 105a to 105e, and enters the collected sound in the sound acquirer 116. The five microphones 105a to 105e collect the sound that comes in different directions from each other. The microphone 105a is disposed at a center of the part where the set of microphones 105 is disposed and collects the sound in front when seen from the robot 300. The microphone 105b is disposed on right of the part where the set of microphones 105 is disposed when seen from the robot 300 and collects the sound that occurs to the right of a sound-collecting range of the microphone 105a. The microphone 105c is disposed on left of the part where the set of microphones 105 is disposed when seen from the robot 300 and collects the sound that occurs to the left of the sound-collecting range of the microphone 105a. The microphone 105d is disposed in a lower part of the part where the set of microphones 105 is disposed when seen from the robot 300 and collects the sound that occurs below the sound-collecting range of the microphone 105a. The microphone 105e is disposed in an upper part of the part where the set of microphones 105 is disposed when seen from the robot 300 and collects the sound that occurs above the sound-collecting range of the microphone 105a.

The sound acquirer 116 shown in FIG. 12 acquires and stores in the RAM the sound that is collected by the set of microphones 105. The sound acquirer 116 acquires the sound that is collected by the microphone 105a when the emotional operation flag is OFF. When the emotional operation flag is ON, the sound acquirer 116 acquires the sound from any of the microphones 105a to 105e so as to acquire the sound that comes in an opposite direction to a direction into which the head 101 is turned. For example, seeing from the robot 300, when the head 101 faces right, the sound acquirer 116 acquires the sound that is collected by the microphone 105c that is disposed on the left of the part where the set of microphones 105 is disposed. Similarly, when the head 101 faces left, the sound acquirer 116 acquires the sound that is collected by the microphone 105b. When the head 101 faces up, the sound acquirer 116 acquires the sound that is collected by the microphone 105d. When the head 101 faces down, the sound acquirer 116 acquires the sound that is collected by the microphone 105e.

The sound analyzer 117 analyzes the sound that is acquired by the sound acquirer 116 and determines the emotion by a tone of a last portion of the sound. If determining that the last portion is toned up, the sound analyzer 117 determines that the sound is the sound of “joy”. If determining that the last portion is toned down, the sound analyzer 117 determines that the sound is the sound of “anger”.

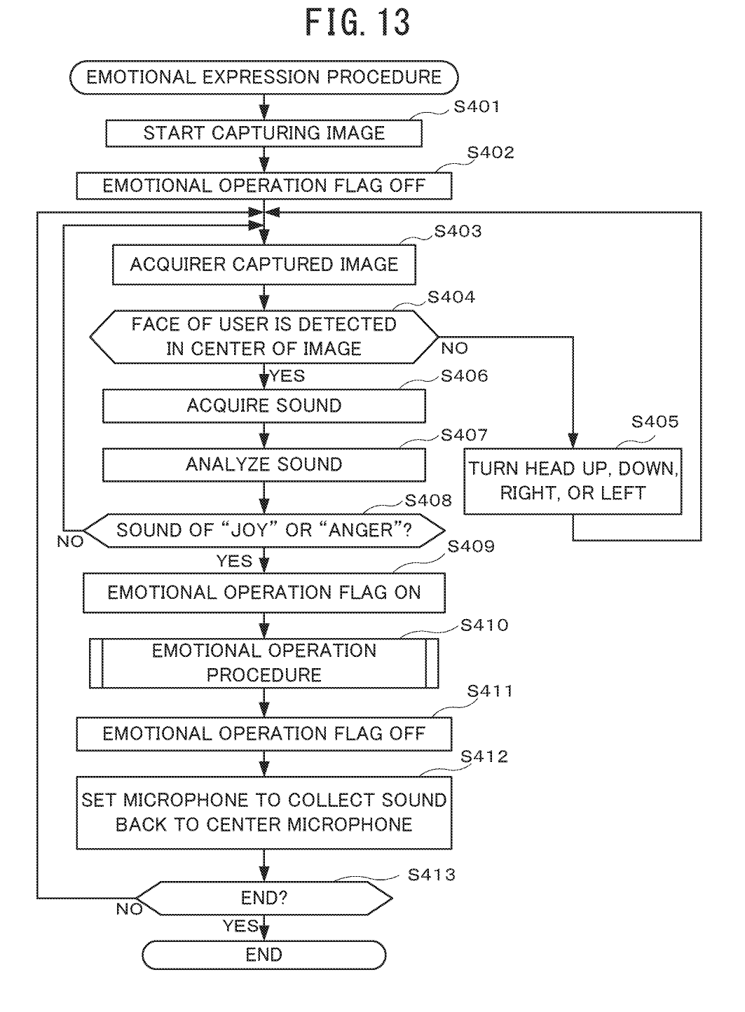

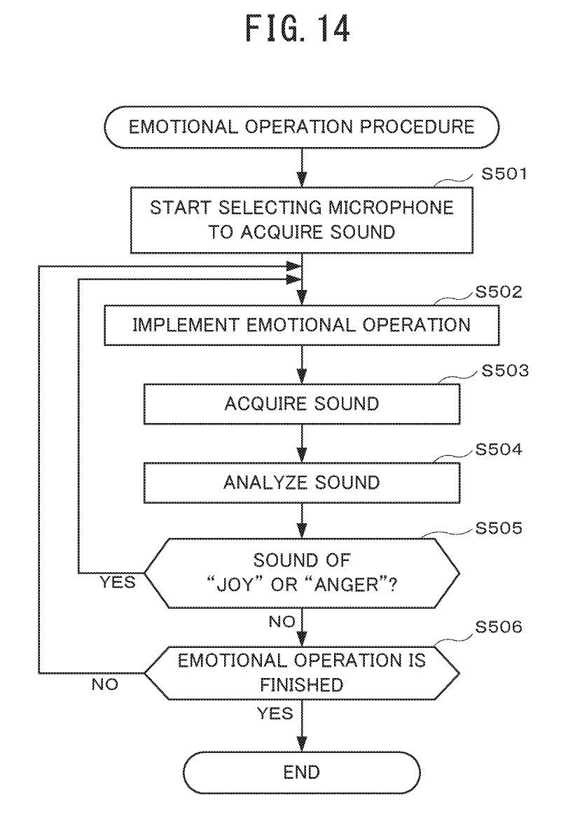

An emotional expression procedure that is executed by the robot 300 that has the above configuration will be described next. Steps S401 through S405 of the emotional expression procedure of the Embodiment 3 are the same as the Steps S101 through S105 of the emotional expression procedure of the Embodiment 1. The emotional expression procedure of Step S406 and subsequent steps will be described with reference to FIG. 13 and FIG. 14.

As shown in FIG. 13, if a determination is made that the face of the user is detected in the center of the acquired image (Step S404; YES), the sound acquirer 116 acquires the sound that is collected by the microphone 105a (Step S406). In this way, the head 101 faces the user and the microphone 105a can collect the sound of the user. Next, the sound analyzer 117 analyzes the acquired sound (Step S407). Next, the sound analyzer 117 determines whether the acquired sound is the sound of “joy” or “anger” (Step S408). For example, if determining that the last portion is toned up, the sound analyzer 117 determines that the acquired sound is the sound of “joy”. If determining that the last portion is toned down, the sound analyzer 117 determines that the acquired sound is the sound of “anger”. Next, if the sound analyzer 117 determines that the acquired sound is not the sound of “joy” or “anger” (Step S408; NO), the processing returns to the Step S403, and the Steps S403 through S408 are repeated.

Next, if the sound analyzer 117 determines that the acquired sound is the sound of “joy” or “anger” (Step S408; YES), the expression controller 113 switches the emotional operation flag to ON and stores the result in the RAM (Step S409). The expression controller 113 executes the emotional operation procedure (Step S410). As the emotional operation procedure starts, as shown in FIG. 14, the sound acquirer 116 starts selecting a microphone to acquire the sound in order to acquire the sound from any of the microphones 105a to 105e so as to cancel the motion of the head 101 out (Step S501).

Next, the expression controller 113 controls the neck joint 103 to make the head 101 operate based on the analysis result of the sound analyzer 117 (Step S502). For example, if the sound analyzer 117 determines that the sound is the sound of “joy”, the expression controller 113 controls the neck joint 103 to make the head 101 oscillate about the pitch axis Xm as the emotional operation to shake the head 101 vertically. If the sound analyzer 117 determines that the sound is the sound of “anger”, the expression controller 113 controls the neck joint 103 to make the head 101 oscillate about the yaw axis Ym as the emotional operation to shake the head 101 horizontally.

Next, the sound acquirer 116 acquires the sound (Step S503). In detail, seeing from the robot 300, when the head 101 faces right, the sound acquirer 116 acquires the sound that is collected by the microphone 105c. When the head 101 faces left, the sound acquirer 116 acquires the sound that is collected by the microphone 105b. When the head 101 faces up, the sound acquirer 116 acquires the sound that is collected by the microphone 105d. When the head 101 faces down, the sound acquirer 116 acquires the sound that is collected by the microphone 105e.

Next, the sound analyzer 117 analyzes the sound that is acquired by the sound acquirer 116 (Step S504). Next, the sound analyzer 117 determines whether the acquired sound is the sound of “joy” or “anger” (Step S505). If the sound analyzer 117 determines that the acquired sound is the sound of “joy” or “anger” (Step S505; YES), the neck joint 103 is controlled to make the head 101 operate based on a new analysis result (Step S502).

If determining that the sound is not the sound of “joy” or “anger” (Step S505; NO), the determiner 114 determines whether the robot 300 has finished the emotional operation by the expression controller 113 or not (Step S506). If the determiner 114 determines that the emotional operation is not finished (Step S506; NO), the processing returns to the Step S502 and the Steps S502 through S506 are repeated until the emotional operation is finished. Here, the expression controller 113 stops the emotional operation when a specific time elapses since the emotional operation starts.

If determining that the emotional operation is finished (Step S506; YES), the determiner 114 returns to FIG. 13 and switches the emotional operation flag to OFF and stores the result in the RAM (Step S411). Next, the sound acquirer 116 sets the microphone to collect the sound back to the microphone 105a (Step S412). Next, the determiner 114 determines whether the end order is entered in the operation button 130 by the user or not (Step S413). If no end order is entered in the operation button 130 (Strep S413; NO), the processing returns to the Step S403 and the Steps S403 through S412 are repeated. If the end order is entered in the operation button 130 (Step S413; YES), the emotional expression procedure ends.

As described above, according to the robot 300, while the emotional expression is implemented, the sound acquirer 116 acquires the sound from any of the microphones 105a to 105e so as to cancel the motion of the head 101 out. As a result, even if the robot 300 turns the head 101, the sound that occurs in front can be collected. Therefore, it is possible to collect the sound that is uttered by the user and analyze the sound even while the emotional expression is implemented and prevent erroneous operations of the robot 300. Moreover, the robot 300 can analyze the sound while the emotional expression is implemented. Hence, for example, when the robot 300 analyzes the sound and determines that the sound is the sound of “anger” while performing the emotional expression of “joy”, the robot 300 can change to emotional expression of “anger”.

### Modified Embodiment of Embodiment 3

The robot 300 of Embodiment 3 is described regarding the case in which the sound acquirer 116 acquires the sound from any of the microphones 105a to 105e so as to cancel the motion of the head 101 out while the emotional operation is implemented. The sound acquirer 116 may suspend acquisition of the sound from the microphones 105a to 105e while the robot 300 implements the emotional operation. Moreover, it may be possible to suspend recording of the sound that is acquired by the sound acquirer 116. In this way, it is possible to prevent the erroneous operation as a result of performing the emotional operation based on the sound that is collected when the robot 300 turns the head 101. In such a case, the robot 300 may include a single microphone. Moreover, instead of the sound acquirer 116 suspending the acquisition of the sound from the microphones 105a to 105e, the sound analyzer 117 may suspend an analysis while the emotional operation is implemented.

### Modified Embodiments

The above embodiments are described regarding the case in which the robots 100, 200, and 300 implement the emotional expression of “joy” and “anger”. However, the robots 100, 200, and 300 have only to execute the expression to the predetermined target such as the user and may express emotions other than “joy” and “anger” or may express motions other than the emotional expression.

The above embodiments are described regarding the case in which the robots 100, 200, and 300 perform the interactive operation through the interaction with the user. However, the case in which the robots 100, 200, and 300 perform a voluntary independent operation with no interaction with the user, which is executed by the robots 100, 200, and 300 by themselves, is similarly applicable.

The above embodiments are described regarding the case in which the image analyzer 112 analyzes the acquired image and determines the facial expression of the user. However, the image analyzer 112 has only to be able to acquire information that forms a base of the operation of the robots 100, 200, and 300 and is not confined to the case in which the facial expression of the user is determined. For example, the image analyzer 112 may determine an orientation of the face of the user or a body movement of the user. In such a case, the robots 100, 200, and 300 may perform a predetermined operation when the face of the user is directed to the robots 100, 200, and 300 or the robots 100, 200, and 300 may perform the predetermined operation when the body movement of the user is in a predetermined pattern.

The above embodiments are described regarding the case in which the imager 104 or 204 is provided at the position of the nose of the head 101. However, the imager 104 or 204 has only to be provided on the head 101, which is the predetermined part, and may be provided at the right eye or the left eye, or may be provided at a position between the right eye and the left eye or at a position of the forehead. Moreover, the imager 104 or 204 may be provided at the right eye and the left eye to acquire a three-dimensional image.

The above embodiments are described regarding the case in which the robots 100, 200, and 300 have the figure that imitates the human. However, the figure of the robots 100, 200, and 300 is not particularly restricted and, for example, may have a figure that imitates an animal including dogs or cats or may have a figure that imitates an imaginary creature.

The above embodiments are described regarding the case in which the robots 100, 200, and 300 include the head 101, the body 102, and the imager 204 that is disposed on the head 101. However, the robot 100 is not particularly restricted as long as the robot 100 can move the predetermined part and the imager 204 is disposed at the predetermined part. The predetermined part may be, for example, hands, feet, a tail, or the like.

The above embodiments are described regarding the case in which the robots 100, 200, and 300 implement expression including the emotional expression to the user. However, the predetermined target to which the robots 100, 200, and 300 implement expression is not restricted to the human and may be the animal such as pets including the dogs and the cats. In such a case, the image analyzer 112 may analyze an expression of the animal.

Moreover, a core part that performs the emotional expression procedure that is executed by the controllers 110, 210, and 310 that include the CPU, the RAM, the ROM, and the like is executable by using, instead of a dedicated system, a conventional portable information terminal (a smartphone or a tablet personal computer (PC)), a personal computer, or the like. For example, it may be possible to save and distribute a computer program for executing the above-described operations on a non-transitory computer-readable recording medium (a flexible disc, a compact disc read only memory (CD-ROM), a digital versatile disc read only memory (DVD-ROM), and the like) and install the computer program on a portable information terminal or the like so as to configure an information terminal that executes the above-described procedures. Moreover, the computer program may be saved in a storage device that is possessed by a server device on a communication network such as the Internet and downloaded on a conventional information processing terminal or the like to configure an information processing device.

Moreover, in a case in which the function of the controllers 110, 210, and 310 is realized by apportionment between an operating system (OS) and an application program or cooperation of the OS and the application program, only an application program part may be saved in the non-transitory computer-readable recording medium or the storage device.

Moreover, it is possible to superimpose on carrier waves and distribute the computer program via the communication network. For example, the computer program may be posted on a bulletin board system (BBS) on the communication network and distributed via the network. Then, the computer program is activated and executed in the same manner as other application programs under the control of the OS to execute the above-described procedures.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A robot, comprising:
an operation unit that causes the robot to operate;
an imager that is disposed at a predetermined part of the robot and captures an image of a subject;
an operation controller that controls the operation unit to move the predetermined part;
a determiner that determines whether the operation controller is moving the predetermined part or not while the imager captures the image of the subject; and
an imager controller that controls the imager or recording of the image of the subject that is captured by the imager, in a case in which the determiner determines that the operation controller is moving the predetermined part, so as to prevent motion of the predetermined part from affecting the image of the subject and causing the operation unit to perform an erroneous operation.

2. The robot according to claim 1, wherein in the case in which the determiner determines that the operation controller is moving the predetermined part, the imager controller suspends capturing by the imager or suspends recording of the image of the subject that is captured by the imager.

3. The robot according to claim 1, wherein in the case in which the determiner determines that the operation controller is moving the predetermined part, the imager controller controls an imaging direction of the imager so as to cancel the motion of the predetermined part out.

4. The robot according to claim 1, further comprising:
a sound acquirer that acquires sound that is collected by a microphone disposed at the predetermined part,
wherein in the case in which the determiner determines that the operation controller is moving the predetermined part, the sound acquirer suspends acquisition of the sound or suspends recording of the sound that is acquired by the sound acquirer.

5. The robot according to claim 1, wherein
the imager captures an image of a predetermined target, and
the operation controller controls the operation unit to move the predetermined part so as to perform an interactive operation through interaction with the predetermined target.

6. The robot according to claim 5, wherein in the case in which the determiner determines that the operation controller is moving the predetermined part, the imager controller acquires the image trimmed so as to include the predetermined target by cutting out a portion of the image of the subject that is the captured image of the predetermined target.

7. The robot according to claim 5, further comprising:
an image analyzer that analyzes a facial expression of the predetermined target,
wherein the operation controller moves the predetermined part so as to present emotional expression to the predetermined target in accordance with the facial expression analyzed by the image analyzer.

8. The robot according to claim 5, further comprising:
a sound acquirer that acquires sounds that are collected by microphones disposed at the predetermined part,
wherein the microphones collect the respective sounds that come from different directions,
the sound acquirer acquires, based on the predetermined target appearing in the image of the subject captured by the imager, a sound that comes from the predetermined target from at least one of the microphones that collects the sound, and
in the case in which the determiner determines that the operation controller is moving the predetermined part, the sound acquirer changes the microphone for acquisition of the sound so as to acquire the sound that comes from the predetermined target.

9. The robot according to claim 1, wherein the operation controller controls the operation unit to move the predetermined part so as to perform a voluntary independent operation that is executed by the robot independently from the predetermined target and that is an operation without interaction with the predetermined target.

10. The robot according to claim 5, wherein the predetermined target is a human or an animal.

11. The robot according to claim 1, wherein in a case in which a procedure to move the predetermined part ends, the operation controller returns the predetermined part to a position at which the predetermined part is located before starting of the procedure to move the predetermined part.

12. The robot according to claim 1, further comprising a body and a neck joint that connects the body to the predetermined part, wherein
the predetermined part is a head, and
the neck joint moves the head with respect to the body based on control of the operation controller.

13. The robot according to claim 12, wherein motion of the head is nodding or shaking of the head.

14. The robot according to claim 7, wherein the operation controller stops the emotional expression in a case in which a specific time elapses since the emotional expression to the predetermined target starts.

15. The robot according to claim 7, wherein
the image analyzer determines a face orientation or a body movement of the predetermined target, and
the operation controller presents the emotional expression in a case in which the face orientation of the predetermined target is directed to the robot, or
the operation controller presents the emotional expression in a case in which the body movement of the predetermined target is in a predetermined pattern.

16. The robot according to claim 7, wherein
the image analyzer determines that the facial expression of the predetermined target is an expression of joy in a case in which a mouth of the predetermined target has a shape with corners upturned, and
the image analyzer determines that the facial expression of the predetermined target is an expression of anger in a case in which the mouth of the predetermined target has a shape with the corners downturned.

17. The robot according to claim 4, wherein
the sound acquirer acquires the sound of the predetermined target,
the robot further comprises a sound analyzer that analyses the sound of the predetermined target, and
the operation controller moves the predetermined part so as to present emotional expression to the predetermined target in accordance with the sound analyzed by the sound analyzer.

18. The robot according to claim 17, wherein
the sound analyzer determines that the sound of the predetermined target is a sound of joy in a case in which a last portion is toned up, and
the sound analyzer determines that the sound of the predetermined target is a sound of anger in a case in which the last portion is toned down.

19. A method for controlling a robot that comprises an operation unit that causes the robot to operate and an imager that is disposed at a predetermined part of the robot and captures an image of a subject, the control method comprising:
controlling the operation unit to move the predetermined part;
determining whether the predetermined part is being moved in the controlling of the operation unit or not while the imager captures the image of the subject; and
controlling the imager or recording of the image of the subject that is captured by the imager, in a case in which a determination is made that the predetermined part is being moved, so as to prevent motion of the predetermined part from affecting the image of the subject and causing the operation unit to perform an erroneous operation.

20. A non-transitory computer-readable recording medium storing a program, the program causing a computer that controls a robot comprising an operation unit that causes the robot to operate and an imager that is disposed at a predetermined part of the robot and captures an image of a subject to function as:
an operation controller that controls the operation unit to move the predetermined part;
a determiner that determines whether the operation controller is moving the predetermined part or not while the imager captures the image of the subject; and
an imager controller that controls the imager or recording of the image of the subject that is captured by the imager, in a case in which the determiner determines that the operation controller is moving the predetermined part, so as to prevent motion of the predetermined part from affecting the image of the subject and causing the operation unit to perform an erroneous operation.
